(19) United States
(12) Patent Application Publication
(10) Pub. No.: US 2024/0027641 A1
(43) Pub. Date: Jan. 25, 2024

(54) COMBINED QUASI-NEWTON AND ADAPTIVE GRADIENT OPTIMIZATION SCHEME USED IN SEISMIC DATA PROCESSING

(71) Applicant: DUG Technology (Australia) Pty Ltd., West Perth (AU)

(72) Inventors: James McLeman, Subiaco (AU); Timothy Burgess, Cottesloe (AU)

(21) Appl. No.: 18/476,877

(22) Filed: Sep. 28, 2023

Related U.S. Application Data
(63) Continuation of application No. PCT/US2022/022169, filed on Mar. 28, 2022.
(60) Provisional application No. 63/167,332, filed on Mar. 29, 2021.

(51) Int. Cl. G01V 1/28; G01V 1/38

(52) U.S. Cl. CPC G01V 1/282; G01V 1/3843

(57) ABSTRACT

A method for determining spatial distribution of properties of formations in a subsurface volume using geophysical sensor signals recorded proximate the volume includes inversion processing an initial model of the spatial distribution. The inversion processing comprises at least second order optimizing. The second order optimizing comprises calculating a scalar for the identity matrix in limited memory Broyden-Fletcher-Goldfarb-Shanno (L-BFGS) optimization, modifying the scalar using an adaptive gradient type scheme to estimate an inverse Hessian matrix, and using the modified plurality of scalars to optimize the inversion processing. The method of estimating the inverse Hessian matrix in L-BFGS can be further extended to include convolutional operators.

### CROSS REFERENCE TO RELATED APPLICATIONS

Continuation of International Application No. PCT/US2022/022169 filed on Mar. 28, 2022. Priority is claimed from U.S. Provisional Application No. 63/167,332 filed on Mar. 29, 2021. Each of the foregoing applications is incorporated herein by reference in its entirety.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### BACKGROUND

This disclosure relates to the field of seismic exploration. More specifically, although not exclusively, the disclosure relates to methods for processing seismic data using inversion to obtain a set of parameters deemed most likely to represent structure and composition of formations in a region of interest in the Earth's subsurface.

A specific challenge in the oil and gas industry is determining the Earth's subsurface properties from data obtained by seismic reflection surveying. In seismic reflection surveying, one or more seismic energy sources are used to impart seismic energy into the Earth, which then propagates as a seismic wavefield. The seismic wavefield interacts with elastic heterogeneities in the subsurface. As a result, some of the seismic energy returns to one or more receivers, which measure properties, e.g., pressure or particle motion, of the seismic wavefield as a function of time at which the seismic source is actuated and location of the receivers. The seismic wavefield can contain a superposition of waves caused by different types of wavefield interaction with features in the subsurface, such waves caused by reflections, refractions, and mode conversion. Combinations of these types of waves are used in many different known processing techniques to help estimate the Earth's subsurface properties and their spatial distribution. Examples of these estimated properties include, without limitation, seismic velocity, seismic anisotropy, acoustic impedance, seismic amplitude versus offset/angle (AVO/A) and reflectivity. Interpretation of acquired seismic data may provide a perceived spatial distribution of such properties in the Earth. Such perceived distribution is referred to as a “model” of the subsurface.

A typical seismic survey provides significantly more acquired data over the surveyed region of interest in the subsurface than there are model parameters. Such acquired data provides that the problem of determining a model of the subsurface (e.g., a spatial distribution of physical properties estimated from the acquired seismic data) is overdetermined. That is, it is generally impossible to find a set of model parameter values that will completely explain all aspects of the collected data. While it is impossible in these circumstances to directly obtain a true solution, that is, a model that correctly represents such subsurface spatial distribution, an estimate of the true solution can be obtained through a process known as inversion which uses assessments of how well the model properties fit with the observed data. See, Vozoff et al., 1975.

The process of inversion uses a forward modelling operator, L, which synthesizes, for seismic data, the wavefield that would have been detected by the seismic receivers (i.e., observed) if the Earth's subsurface had formations and their properties spatially distributed as described by an input model of the subsurface. The modelling operator may be, for seismic surveying, some appropriate form of a wave equation. The resulting synthetic (“modelled”) data are then compared with the observed (measured) data and any differences between the two are assumed to be due to errors in the model, whether values of the properties, their spatial distribution or both. The difference between the modelled and observed data is termed the “residual” vector. In order to improve the fit between the modelled and observed data, and thus reduce the errors in the model, a quantitative measure of misfit between the modelled and observed data is required. This quantity is often called the “cost” or “objective” function. To illustrate this disclosure, we will define a “residual vector” as the difference between the modelled and observed data, and choose as the objective function the square of the “L₂ norm” of this residual vector. Methods based upon the L₂-norm are often referred to as “least squares” methods because they seek to minimize the sum of the squared errors. However, it is to be understood that other measures of the misfit also fall within the scope of this disclosure and that use of the L₂-norm to illustrate the technique is not intended to be a limitation on the scope of the present disclosure . . . . The goal of inversion processing is to find model properties which minimize the cost or objective function. When the objective function is minimized, the modelled data matches the recorded data in a least squares sense. If the model properties are not yet optimal, then it is necessary to change them in a way that improves the L₂ norm of the residual vector. Known inversion methods obtain such results by applying the “adjoint state” method to the modelling operator, which allows determination of the gradient of the objective function with respect to values of the model parameters. The gradient describes how incremental changes in the model parameter values affect the value of the objective function, and thus permits selection of a direction in which one or more of the model parameters needs to be adjusted or changed to improve the fit of the modelled data to the observed data. The precise set of new model properties that will improve the fit may be calculated by an optimization algorithm such as steepest descent or L-BFGS (the limited memory Broyden-Fletcher-Goldfarb-Shanno (BFGS) algorithm). These steps are repeated until the L₂ norm is “sufficiently small” (e.g., is below a selected threshold) or some other inversion stopping criterion is satisfied. Formally, the objective function may be given by the expression:

J=∥L(m)−d∥₂² (1)

where J is the objective function, L is the modelling operator which describes how to synthesize data from the model properties, m, and d represents the observed data.

The term “parameter class” may be used to signify a particular type of model parameter, such as velocity or density. Inversion, where more than one parameter class is sought, is commonly referred to as “multi-parameter” inversion. Multi-parameter inversion presents an additional challenge if there is coupling between two or more of the parameter classes, resulting in what is termed “cross-talk” (Operto et al., 2013). Under these circumstances the inversion may attribute some of the energy in the residual vector to one or more of the wrong parameter classes. This occurs because perturbations in parameters of different classes can have a similar effect on the modelled data. For example, consider a hypothetical experiment in which an anisotropy parameter class is already correctly specified and that an inversion is then performed in which both velocity and seismic anisotropy are sought. Since it is common for the wavefield arrival time to be influenced by both velocity and seismic anisotropy, time differences between the modelled and observed data can be ascribed to both velocity and seismic anisotropy. The foregoing hypothetical inversion could adjust originally correct (best fitting) seismic anisotropy parameters so that they are no longer correct, while insufficient modification may have been ascribed to velocity. The inversion may not be able to recover from these conditions without further operator/user intervention. FIG. 1A demonstrates a simple case of an objective function when model parameters are coupled, and FIG. 1B shows an objective function when model parameters are not coupled.

When both model parameters in FIGS. 1A and 1B have an error of 0, the objective function is at a minimum. In FIG. 1A the objective function is elongated along an oblique direction to the parameter axes. A simple optimizer takes steps downhill in the direction perpendicular to the contours at each iteration. Therefore, if model parameter 1 starts with error 0 and model parameter 2 starts with error −1, the first iteration will place an error in parameter 1. In FIG. 1B, however, the same starting point does not lead to cross-talk.

A second consideration in multi-parameter inversion is where different parameter classes have different scales. For example, in seismic exploration, compressional (p-wave) velocity will be of the order of 1500-6000 meters per second (m/s), whereas common anisotropy values are of the order of 0.01-0.2. This difference in scale is 4-5 orders of magnitude between model parameter classes, which means that a change in the value of parameters in some classes produces a larger variation in the objective function than a similar-magnitude change in parameters of other classes. The same issue arises in single parameter class inversion if the model properties have a wide range of sensitivities. For example, seismic waves may illuminate some regions of the Earth's subsurface much more than others, which leads to the weakly-illuminated regions having much less influence on the objective function. Poorly scaled parameters and weak “illumination” typically result in slow inversion convergence rates because the direction of descent will be biased towards some parameters and have elongated objective functions like those shown in FIGS. 1A and 1B.

FIG. 2 shows an objective function where both model parameters are appropriately scaled. In FIG. 2, parameter sensitivity (scale differences) has been reduced using parameter scaling to stretch or squeeze the objective function. An approach that combines the effects of both rotation and stretching/squeezing on the inversion uses the “Hessian matrix”, H, which is described below.

There are many optimization algorithms that can be used to solve inversion problems, each with attendant strengths and weaknesses. For example, first order optimization methods like “steepest descent” only make use of the gradient and the model parameters from the previous iteration in a set of iterations. For a single iteration, this is simple and computationally cheap. However, because it suffers from parameter cross-talk and scale differences, convergence is slow and requires many iterations. The convergence rate of the steepest descent method can be improved by exploiting a more extensive history of previous steps, rather than simply relying on the last step. Examples of this are “momentum” techniques, “adaptive gradient” approaches (sometimes called “AdaGrad”, which may refer to Duchi et al., 2011, or the closely related Shampoo technique (Gupta et al., 2018)) and RMSprop (Hinton, 2018). However, for complex non-linear problems, higher order optimization schemes may perform better than first order optimization.

Second order optimization approaches, for example, make use of the gradient (which, as described above, is the first derivative of the objective function with respect to the model parameters) and second derivative information. The second derivative may be described by the Hessian matrix (sometimes simply “Hessian”), which succinctly provides information about the curvature of the objective function. “Newton's method” (Newton, 1711; Raphson, 1690) is an example of a second order optimization scheme using the Hessian. As a result, it converges much faster than steepest descent and is relatively immune from cross-talk and scaling issues. However, implementation of Newton's method on large problems with billions of unknowns is not practical because it requires that the Hessian matrix be formed explicitly in the computer memory and that the inverse Hessian, H⁻¹, be well defined. Consequently, approaches that approximate the inverse Hessian matrix at each iteration, known as “quasi-Newton” methods, have been developed e.g., the BFGS method described above. The BFGS method uses the complete history of all iterations in an inversion to build an approximate inverse Hessian matrix. However, for such large problems, even using the BFGS approach, it is prohibitive to store, e.g., in computer memory, the necessary information from all previous iterations. A modification of this approach, limited memory BFGS Broyden-Fletcher-Goldfarb-Shanno or “L-BFGS optimization”, uses a diagonal-plus-low-rank approximation of the inverse Hessian matrix constructed using only a few of the most recent iterations, instead of the complete history. L-BFGS is practical for large-scale problems, and converges faster than steepest descent. However, because of the nature of the L-BGFS approximation, it does not adequately deal with cross-talk and parameter scaling.

Even though a good estimate of the inverse Hessian matrix is important for multi-parameter inversion, it is also important for single parameter class inversion. The sensitivity of the model parameters varies for several reasons, including the geometry of acquisition and the parameter (e.g., velocity) spatial distribution of the Earth. Unless all parts of any particular region of interest in the Earth were adequately illuminated by seismic waves, there will be weak, or no, information about those parts of the Earth. As a result, convergence will be slow. If the full Hessian could be computed and it was sufficiently well-conditioned to be inverted, then the inverse Hessian would fully compensate for illumination and cross-talk. Unfortunately, lesser approximations used in quasi-Newton methods have more limited ability to provide compensation for illumination and resolve cross-talk. As a result, it is common practice to additionally include “preconditioners” to assist in aspects such as illumination compensation and to generally help accelerate convergence in quasi-Newton inversion schemes.

An alternative method to estimate the inverse Hessian efficiently involves the use of “matching filters” (Guitton, 2017). This method makes use of the prior knowledge that the effect of model parameter changes on the gradient (which is the information contained in the Hessian matrix) is approximately localized around the position of the modified model parameter.

There continues to be a need for inversion processing methods which better address scaling and cross-talk.

### SUMMARY

One aspect of the present disclosure is a method for determining spatial distribution of properties of formations in a subsurface region of interest using geophysical sensor signals detected proximate the region of interest. The method includes inversion of an initial model of the spatial distribution. The inversion comprises at least second order optimization. The second order optimization comprises substitution of a scaled identity matrix in limited memory Broyden-Fletcher-Goldfarb-Shanno (L-BFGS) optimization with an alternative scaled matrix βM with the values comprising the matrix M being derived from a combination of data obtained at previous iteration steps and prior knowledge of the nature of the inversion problem, and using this substituted matrix M to improve the inversion.

Another aspect of this disclosure is a computer program stored in a non-transitory computer readable medium. The program has logic operable to cause a programmable computer to perform actions for determining spatial distribution of properties of formations in a region of interest in the Earth's subsurface using geophysical sensor signals detected proximate the region of interest. The actions include accepting as input to the computer the geophysical sensor signals and inversion of an initial model of the spatial distribution. The inversion comprises at least second order optimization. The at least second order optimization comprises substitution of a scaled identity matrix in limited memory Broyden-Fletcher-Goldfarb-Shanno (L-BFGS) optimization with an alternative scaled matrix βM with values comprising the alternative matrix M being derived from a combination of data obtained at previous iteration steps and prior knowledge of the nature of the inversion problem, and using the alternative scaled matrix βM to improve the inversion. The initial model is finalized when a value of an objective function in the inversion processing is minimized.

Another aspect of this disclosure relates to a method for determining spatial distribution of properties of formations in a region of interest in the subsurface using geophysical sensor signals detected proximate the region. The method according to this aspect includes inversion processing an initial model of the spatial distribution. The inversion processing comprises at least second order optimization. The at least second order optimization comprises calculating an estimate of an inverse Hessian as a convolutional operator (C), and using the estimated inverse Hessian matrix in a modified limited memory Broyden-Fletcher-Goldfarb-Shanno (L-BFGS) optimization. The modified L-BFGS optimization is used to optimize the inversion processing.

A computer program stored in a non-transitory computer readable medium according to another aspect of this disclosure includes logic operable to cause a programmable computer to perform actions including the following. An initial model of spatial distribution of properties of formations in a region below the Earth's surface is entered into the computer, along with measurements relating to the properties. The initial model is inversion processed. The inversion processing comprises at least second order optimization. The at least second order optimization comprises calculating an estimate of an inverse Hessian as a convolutional operator (C), and using the estimated inverse Hessian in a modified limited memory Broyden-Fletcher-Goldfarb-Shanno (L-BFGS) optimization. The modified L-BFGS optimization is used to optimize the inversion processing. For any one or more of the foregoing aspects of this disclosure, the following may apply.

Inversion processing in the various aspects of the present disclosure includes calculating expected geophysical sensor signals using an initial model of the spatial distribution. The expected geophysical sensor signals are compared to the detected signals. In the various aspects of the present disclosure, the optimized inversion provides as an output a spatial distribution, i.e., an updated model thereof, for which calculated expected geophysical sensor signals most closely match the detected signals.

In some embodiments, the geophysical sensor signals comprise seismic signals.

In some embodiments, values comprising an alternative scaled matrix M are derived from previous iteration steps using an adaptive gradient—(AdaGrad) type scheme.

In some embodiments, off-diagonal adaptive gradient terms are included to improve estimation of the inverse Hessian matrix.

In some embodiments, the alternative scaled matrix M is described as a non-stationary convolutional operator (C) or linear combination of convolutional operators or a product of convolutional operators or a combination of products of convolutional operators and linear combinations of convolutional operators.

In some embodiments, the convolutional operators are derived from previous iteration steps using match filtering (F).

In some embodiments, off-diagonal terms in the estimated inverse Hessian matrix are modified to preserve a positive definite property.

In some embodiments, the match filtering is performed in a transformed domain comprising at least one of curvelet, Fourier, radon or wavelet domain.

In some embodiments, the match filtering is applied in at least one dimension.

In some embodiments, match filtering is applied in overlapping windows.

In some embodiments, the adaptive gradient type scheme is regularized and/or constrained.

In some embodiments, the estimated inverse Hessian matrix (βM) is obtained using a combination of data obtained at previous iteration steps.

Other aspects and possible advantages will be apparent from the description and claims that follow.

### BRIEF DESCRIPTION OF THE DRAWINGS

FIG. 1A shows a graphic explanation of minimizing an objective function in inversion processing where model parameters are coupled.

FIG. 1B shows a graphic explanation similar to FIG. 1A wherein the parameters are not coupled.

FIG. 2 shows minimizing an objective function where model parameters are suitably scaled.

FIG. 3 shows an example embodiment of acquiring seismic data that may be used in accordance with the present disclosure.

FIG. 4 shows a simplified flow chart of an example embodiment of a method.

FIG. 5 shows a graph illustrating the reduction in the objective function as a function of iteration for the present method as contrasted with prior methods.

FIG. 6 shows an example computer system that may be used in some embodiments.

### DETAILED DESCRIPTION

Embodiments of a method according to the present disclosure may have particular application in and are described with reference to processing seismic data, however, such processing is not intended to limit the scope of the present disclosure. Moreover, without limiting the generality of uses to which methods according to this disclosure may apply, such methods may be used with any form of geophysical sensor data or geophysical sensor signals, that is, any data or signals obtained by one or more sensors in response to naturally occurring phenomena such as natural gamma radiation or voltage impressed on an electrode in a well (spontaneous potential), or induced in the sensor in response to imparting energy into the earth, such as electromagnetic energy to measure resistivity, acoustic energy to measure acoustic velocity, or nuclear radiation to measure density or neutron porosity.

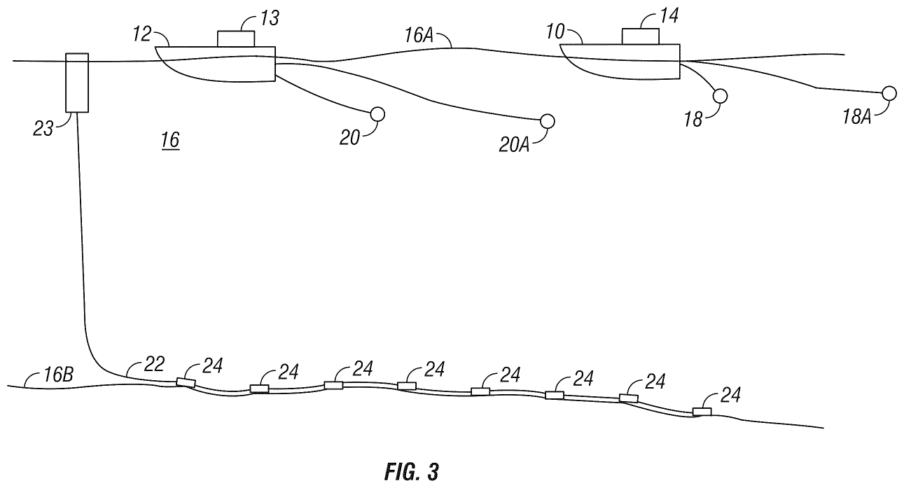

FIG. 3 shows a vertical section view of an example embodiment of a marine seismic survey being conducted using, for example, two different “source” vessels for towing seismic energy sources. The data acquired using a system as shown in FIG. 3 may be processed according to example embodiments of a method provided in this disclosure.

In some embodiments, only one source vessel may be used. According to the present disclosure, any number of source vessels may be used and the following description is not intended to limit the scope of the present disclosure. The source vessels move along the surface 16A of a body of water 16 such as a lake or the ocean. In the present example, a vessel referred to as a “primary source vessel” 10 may include equipment, shown generally at 14, that comprises components or subsystems (none of which is shown separately) for navigation of the primary source vessel 10, for actuation of seismic energy sources and for retrieving and processing seismic signal recordings. The primary source vessel 10 is shown towing two, spaced apart seismic energy sources 18, 18A.

The equipment 14 on the primary source vessel 10 may be in signal communication with corresponding equipment 13 (including similar components to the equipment on the primary source vessel 10) disposed on a vessel referred to as a “secondary source vessel” 12. The secondary source vessel 12 in the present example also tows spaced apart seismic energy sources 20, 20A near the water surface 16A. In the present example, the equipment 14 on the primary source vessel 10 may, for example, send a control signal to the corresponding equipment 13 on the secondary source vessel 12, such as by radio telemetry, to indicate the time of actuation (firing) of each of the sources 18, 18A towed by the primary source vessel 10. The corresponding equipment 13 may, in response to such signal, actuate the seismic energy sources 20, 20A towed by the secondary source vessel 12.

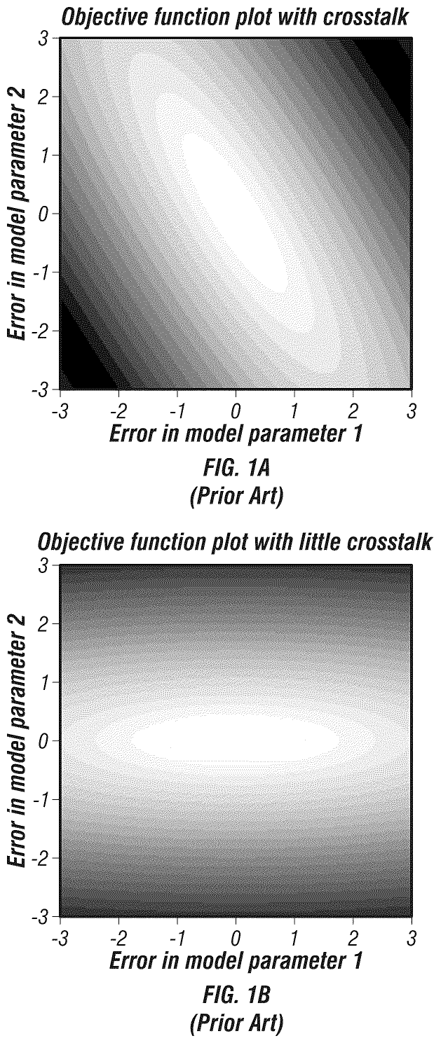

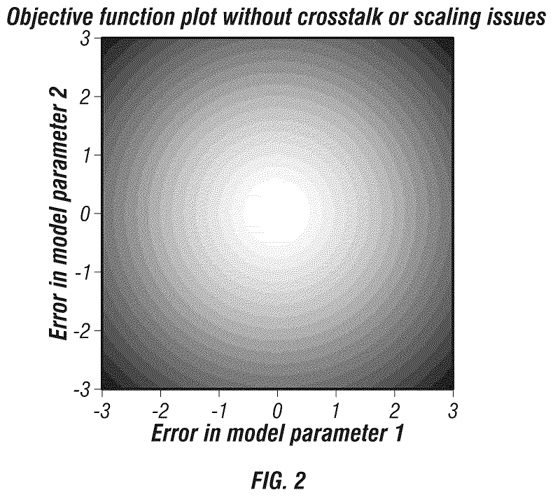

The seismic energy sources 18, 18A, 20, 20A may be, for example and without limitation, air guns, water guns, marine vibrators, or arrays of such devices. The seismic energy sources are shown as discrete devices in FIG. 1 to illustrate the general principle of seismic signal acquisition. The type of and number of seismic energy sources that can be used in any example is not intended to limit the scope of the disclosure.

In FIG. 3, an ocean bottom cable (OBC) 22 may be deployed on the bottom 16B of the water 16 such that spaced apart seismic receiver modules 24 are disposed on the water bottom 16B in a preselected pattern. The receiver modules 24 may include a pressure or pressure time gradient responsive seismic sensor, and one or more seismic particle motion sensors, for example, one-component or three-component geophones, or one- or three-component accelerometers (none of the sensors are shown separately). The type of and the number of seismic sensors in each module 24 is not intended to limit the scope of the disclosure. The seismic sensors in each module 24 generate electrical and/or optical signals (depending on the sensor type) in response to, in particular, detected seismic energy resulting from actuations of the seismic energy sources 18, 18A, 20, 20A. In some embodiments, the sensors may comprise pressure or pressure time derivative sensors such as hydrophones, and one or more particle motion responsive sensors such as geophones or accelerometers. In some embodiments, such particle motion responsive sensors may be oriented so as to be sensitive principally (ignoring any cross-component coupling for purposes of explanation) to vertical particle motion. The signals generated by the various sensors may be conducted to a device near the water surface 16A such as a recording buoy 23, which may include a data recorder (not shown separately) for storing the signals for later retrieval and processing by the equipment 14 on the primary source vessel 10, or other processing equipment to be described further below. The data storage functions performed by the recording buoy 23 may be performed by different types of equipment, such as a data storage unit on a recording vessel (not shown) or a recording module (not shown) deployed on the water bottom 16B, e.g., proximate each sensor module 24, or even on the primary or secondary source vessels. Accordingly, the disclosure is not limited in scope to use with a recording buoy or any other specific recording device(s).

Although the description of acquiring signals explained with reference to FIG. 3 is for sensors deployed on the water bottom, it will be appreciated that it is possible to obtain corresponding measurements at any selected depth in the water, using, for example, seismic sensors disposed in a towed cable such as described in U.S. Pat. No. 7,239,577 issued to Tenghamn, et al.

Having explained an example method for acquiring seismic data, the present disclosure will now explain example embodiments of data processing methods. In general, data processing according to the present disclosure comprises inversion processing. Seismic data, which represent recorded seismic signals made by a plurality of spaced apart seismic sensors with respect to time of actuation of one or more seismic sources, e.g., as in FIG. 3, may be considered the observed data (or measured data or measured signals) for inversion. An initial earth model of subsurface formations is generated. The initial model comprises at least one formation property or parameter, e.g., seismic compressional velocity, whose value and spatial distribution in the subsurface affects the observed signals. A forward model of expected seismic data is generated from the initial earth model. The forward model represents the observed data that would be obtained if the spatial distribution of the formation property or parameter matched the distribution in the initial model. The forward model is compared to the observed data and an objective function is calculated. The objective function corresponds to differences between the observed data and the forward model. The initial earth model is adjusted, the forward model is recalculated from the adjusted initial earth model and the recalculated forward model is again compared to the observed data. The foregoing may be repeated until the objective function is minimized. As explained in the Background section herein, direction (sign) and amount of adjustment of the at least one parameter will affect how rapidly (i.e., the number of iterations) the inversion reaches a minimum value of the objective function.

In this disclosure, at least second order optimization is performed. In the present example embodiment, a novel combination of limited memory Broyden-Fletcher-Goldfarb-Shanno (L-BFGS) optimization with a general adaptive gradient (AdaGrad) type scheme may be performed, along with an optional extension to include the use of match filtering. The extension to include match filtering can be used with or without the inclusion of the adaptive gradient (AdaGrad) type scheme. A method according to the present disclosure to estimate the inverse Hessian matrix in L-BFGS optimization may improve the inversion in the presence of cross-talk, may apply suitable parameter scaling and may accelerate convergence to a solution (the recalculated earth model that results in minimized objective function). Methods according to the present disclosure are well suited to not only multi-parameter inversion, but also to single parameter class inversion. The disclosed method(s) may eliminate the need for illumination compensation preconditioners in inversion processing.

L-BFGS is a second order quasi-Newton optimization method that has as an objective of approximating or estimating the inverse Hessian matrix (Ĥ⁻¹) with a (computer) memory efficient diagonal-plus-low-rank representation. An important step in this approach, which is known in the art, estimates the diagonal part of the approximation from a scaled version of the identity matrix, Ĥ⁻¹=αl, where the scalar α is based on the curvature along the most recent search direction (Nocedal and Wright, 2006) and I is the identity matrix. The foregoing may be expressed as:

$$α = \frac{{s}^{T} y}{{y}^{T} y} \qquad ( 2 )$$

where y and s are the change in gradient and the change in the model, respectively, since the previous inversion iteration. L-BFGS requires that the approximated or estimated inverse Hessian matrix is “positive definite” (that is, x^{T}H⁻x>0 for an arbitrary vector, x). This criterion must be met in order to obtain a decrease in the objective function at each iteration. To be positive definite requires that the scalar is positive, that is, α>0 in Eq. (2). Such condition results because the Wolfe conditions (Wolfe, 1969) determine that s^{T}y >0 and so it must also be the case that y^{T}y>0. Using alpha (α) derived from Eq. (2) results in the unit step length being likely to satisfy the Wolfe conditions. The foregoing scalar, α, can be thought of as a constant stretching or squeezing of the objective function space.

In an inversion where the inverted parameters are of different scales, a scalar multiple of the identity matrix is inappropriate because the single scalar will not compensate for the difference in sensitivities between or among the parameters. A single scalar also fails to take account of the range of possible scales that might exist in a single parameter class due to variations in illumination.

A possible improvement disclosed herein is to choose a plurality of scalars, q=pm scalars, where p is the number of parameter classes and m is the number of elements in each parameter class. These scalars can be obtained by using an AdaGrad type method, and this appears to help improve the L-BFGS inverse Hessian estimation. It is proposed initially to modify αI to become β_{Diag}M_{Diag}, in which the new quantity β_{diag} is provided by the expression:

$${β}_{D i a g} = \frac{{s}^{T} y}{{y}^{T} {M}_{D i a g} y} , \qquad ( 3 )$$

with the diagonal matrix, M_{Diag} given by the expression:

$${M}_{D i a g} = {[ diag ( {\sum }_{i = 0}^{n} {g}_{i} {g}_{i}^{T} ) + ε ]}^{- \frac{1}{2}} . \qquad ( 4 )$$

Here, n is the number of iterations, g is the gradient and ε is a small number to stabilize the division. Note that like α, it is guaranteed that β_{Diag}>0, which is necessary to ensure that the positive definite property required by L-BFGS is preserved. As there are now many scalars as opposed to just one, the functional space can be stretched or squeezed by different amounts in different directions. The inversion is free to warp (but not rotate) the functional space to provide a more optimal decrease in the objective function in each iteration.

This approach is not limited to just improving the diagonal estimate of the inverse Hessian matrix as shown above, but off-diagonal terms can be included to help reduce parameter cross-talk too. For example, using:

$${M}_{S} = {[ S ∘ {\sum }_{i = 0}^{n} {g}_{i} {g}_{i}^{T} + ε ]}^{- \frac{1}{2}} and {β}_{S} = \frac{{s}^{T} y}{{y}^{T} {M}_{S} y} . \qquad ( 5 )$$

where S is some sparsity imposing matrix (which could be as simple as the identity matrix, yielding the scheme described above) and “∘” denotes Hadamard (element-by-element) product. S controls which components of Σᵢ₌₀ⁿgᵢgᵢ^{T} are used to calculate M_{S}. For example, selection of the diagonal and additional off-diagonal elements can be used to describe illumination compensation and coupling between model parameter classes. This rotates as well as stretches/squeezes the objective function. There is no guarantee that the inclusion of off-diagonal elements will automatically satisfy the positive definite requirement. However, Schur's product theorem guarantees that the Hadamard product of two positive definite matrices is also positive definite. Therefore, so long as both Σᵢ₌₀ⁿgᵢgᵢ^{T} and S are positive definite then the positive definite requirement is guaranteed to be met.

An improvement on the estimate of the inverse Hessian can also be achieved using non-stationary convolutional operators, such as match filters. In this case, an improvement of the estimate of the inverse Hessian in L-BFGS is sought by finding a matching filter operator, F, such that:

Fy≅s (6)

This approach can be combined with the AdaGrad type scheme in the following way:

$$β F M y ≅ s and β = \frac{{s}^{T} y}{{y}^{T} F M y} \qquad ( 7 )$$

subject to the positive definite requirement that y^{T}βFMy>0. Note that M can be any implementation mentioned above. Indeed, M could also represent any combination of data obtained at previous iteration steps and prior knowledge of the nature of the inversion problem. Recall, s is the change in the model parameter(s) due to the most recent inversion iteration and y is the change in gradient of the objective function due to the most recent iteration. Both are symbolically ordered as vectors, but in reality, they may be thought of as 3 or 4-dimensional volumes of parameter classes that are the same size as the model, m. Although the match filter operator bears similarities to Guitton's match filters, the present match filters are designed on different inputs and applied in a substantially different way. The matching filter F represents a filtering operator over n dimensions which can be constructed using linear or non-linear least squares. Although n may include 1 to 3 spatial dimensions, for example Cartesian coordinates (x, y, z), even higher dimensions are possible. Indeed, the domain in which the matched filters are designed and/or applied is not limited to the conventional space domain of (x, y, z), but can include, but is not limited to, transform domains such as Fourier, Radon, curvelet and wavelet transforms. The matching filters are non-stationary and may be computed in an overlapping windowed scheme. It is important to note that the matching filters may enhance the estimate of both the diagonal and off-diagonal terms of the inverse Hessian, which reduces the number of iterations required to obtain a satisfactory convergence.

F need not be restricted to match filtering or limited to a single type of operation. Generally, providing that the positive definite requirement is met, any number of operators, C_{k, j}, can be used to better approximate the L-BFGS inverse Hessian. These operators may, for example, be some mixture of products and linear combinations, according to the following expression:

βΣⱼ₌₁^{j=p}(Πₖ₌₁^{k32 wk=}C_{k,j})My=s (8)

where wp is the total number of operators. These additional operators may be used flexibly to represent such things as useful a priori knowledge about the inverse Hessian to better condition the optimization. Although this has been written above in a form for use with an AdaGrad-type scheme it may also be used without AdaGrad by setting M=I and β=1.

Using the above formulation, initially each parameter class, and preferably every element in the model will receive an equal weight in the inversion. With each subsequent iteration every element in the model will receive updated weights that modify the sensitivity of the objective function to each element of the model, so that the relative sensitivities and coupling of the various parameters are compensated. This compensates for any natural parameter bias and variations in illumination. As a result, it is not necessary to use preconditioners to compensate for illumination deficiencies. The original L-BFGS formulation, which uses a multiple of the identity matrix as part of its inverse Hessian estimation, has been replaced with quantities that can vary adaptively between parameter classes for each element in the model, significantly accelerating convergence.

Because real data contains noise as well as signal, regularization may be included to reduce the influence of noise on the inversion process.

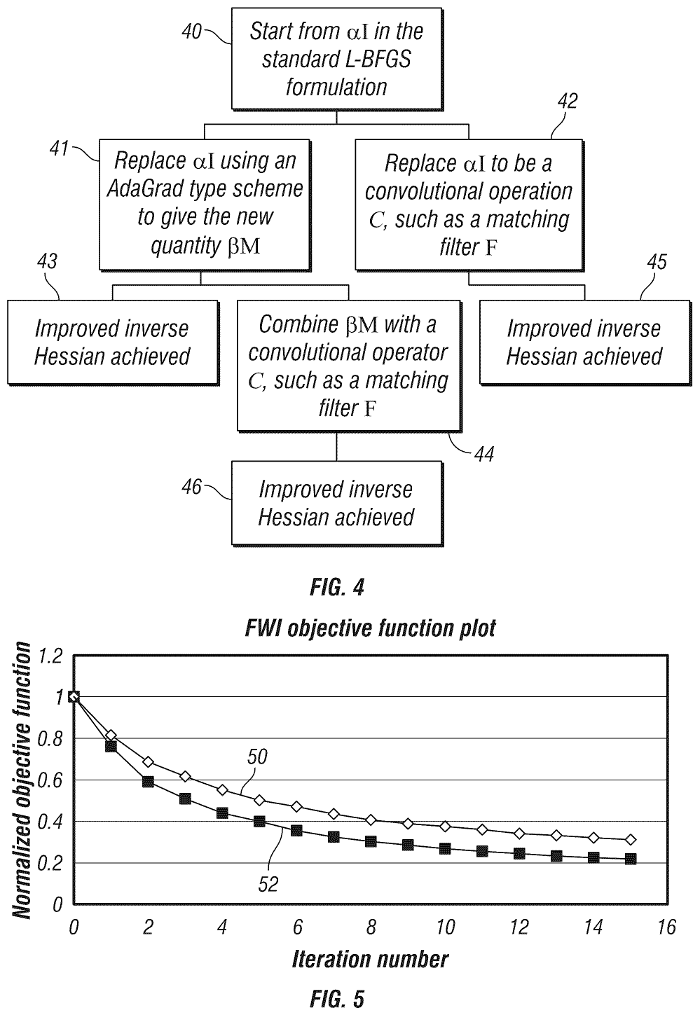

A high-level flowchart illustrating the present example embodiment of a method is shown in FIG. 4. At 40, the conventional L-BFGS optimization is shown in which the scalar α is determined, to scale the identity matrix as αI to estimate the inverse Hessian. At 41, one optional proposed modification is shown in which the scaled identity matrix αI is replaced by βm using an adaptive gradient type scheme according to Eq. (3) and Eq. (4), which at 43 then obtains an improved inverse Hessian. In some embodiments, and as shown at 44, βM may be combined with a convolution operator, F, such as a matching filter, for example using Eq. (7) so that βM→βFM. The result, shown at 46, is an improved inverse Hessian.

In some embodiments, at 42, the scaled identity matrix αI is replaced by non-stationary match filters, F using Eq. (6), to directly obtain an improved inverse Hessian, as shown at 45.

### Examples

In an example using an embodiment of a method according to the present disclosure, a marine 3D survey with 2 sources and 12 streamers has been used, e.g., as explained with reference to FIG. 1 using streamers instead of OBCs. Diving wave Full Waveform Inversion (FWI) (see, Tarantola 1984; Plessix, 2006) was applied to obtain p-wave velocity from the recorded seismic signals. The FWI was run twice; once using a known L-BFGS optimizer and once using an improved L-BFGS scheme according to the present disclosure. FIG. 5 shows the reduction in the objective function as a function of iteration for the known L-BFGS method at 50 and using an improved L-BFGS method according to the present disclosure at 52. After 15 iterations, using the known L-BFGS method, the objective function is approximately the magnitude as by using the new L-BFGS approach after only 7 iterations. Using a method of optimization according to the present disclosure has demonstrated a significant reduction in computational effort to obtain similar improvements in the objective function.

A new optimization scheme combining a quasi-Newton L-BFGS optimizer with an adaptive gradient type approach to improve inverse Hessian estimation has been disclosed. It has also been disclosed that application of convolution filters, such as matching filters, or more generally any suitable operator can be accommodated into the structure of this scheme so long as they improve the estimate of the inverse Hessian. The improved estimate of the inverse Hessian helps to mitigate cross-talk between parameter classes in multi-parameter inversion and to scale the sensitivity of the objective function to each model element. This is achieved by modifying the diagonal and off-diagonal elements of the inverse Hessian which rotates and stretches/squeezes the objective function. As a result, illumination compensation occurs more naturally without the need for preconditioners. The convergence rate of this new approach on large scale problems is significantly faster than the standard L-BFGS approach.

Although this new approach has been disclosed in relation to seismic exploration, the new method has considerable general application in many other areas of endeavor that could have otherwise used the standard L-BFGS approach.

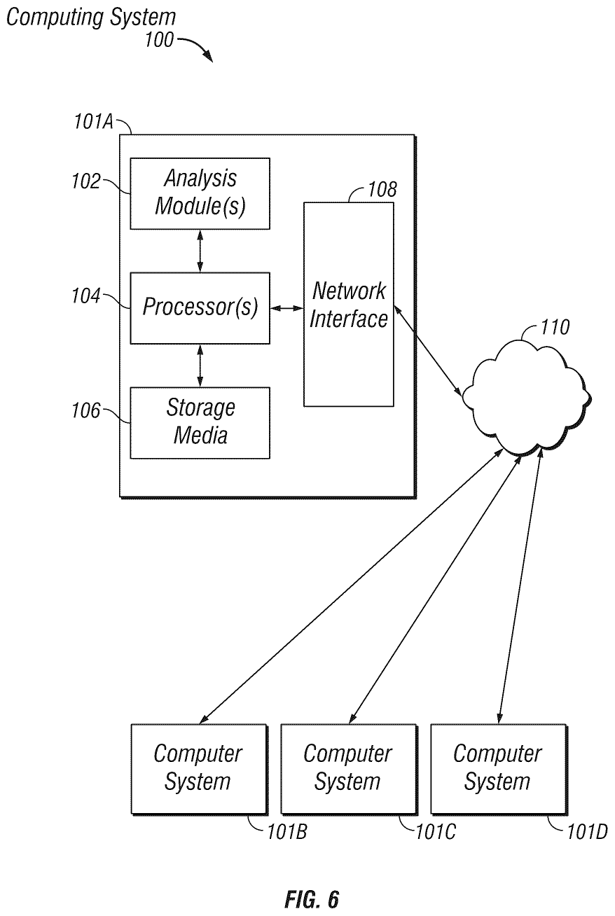

All of the above calculations may be performed in any general purpose or purpose specific computer or processor. FIG. 6 shows an example computing system 100 in accordance with some embodiments. The computing system 100 may be an individual computer system 101A or an arrangement of distributed computer systems. The individual computer system 101A may include one or more analysis modules 102 that may be configured to perform various tasks according to some embodiments, such as the tasks explained with reference to FIGS. 3-5. To perform these various tasks, the analysis module 102 may operate independently or in coordination with one or more processors 104, which may be connected to one or more storage media 106. A display device such as a graphic user interface of any known type may be in signal communication with the processor 104 to enable user entry of commands and/or data and to display results of execution of a set of instructions according to the present disclosure.

The processor(s) 104 may also be connected to a network interface 108 to allow the individual computer system 101A to communicate over a data network 110 with one or more additional individual computer systems and/or computing systems, such as 101B, 101C, and/or 101D (note that computer systems 101B, 101C and/or 101D may or may not share the same architecture as computer system 101A, and may be located in different physical locations, for example, computer systems 101A and 101B may be at a well drilling location, while in communication with one or more computer systems such as 101C and/or 101D that may be located in one or more data centers on shore, aboard ships, and/or located in varying countries on different continents).

A processor may include, without limitation, a microprocessor, microcontroller, processor module or subsystem, programmable integrated circuit, programmable gate array, or another control or computing device.

The storage media 106 may be implemented as one or more computer-readable or machine-readable storage media. Note that while in the example embodiment of FIG. 6 the storage media 106 are shown as being disposed within the individual computer system 101A, in some embodiments, the storage media 106 may be distributed within and/or across multiple internal and/or external enclosures of the individual computing system 101A and/or additional computing systems, e.g., 101B, 101C, 101D. Storage media 106 may include, without limitation, one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that computer instructions to cause any individual computer system or a computing system to perform the tasks described above may be provided on one computer-readable or machine-readable storage medium, or may be provided on multiple computer-readable or machine-readable storage media distributed in a multiple component computing system having one or more nodes. Such computer-readable or machine-readable storage medium or media may be considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100 is only one example of a computing system, and that any other embodiment of a computing system may have more or fewer components than shown, may combine additional components not shown in the example embodiment of FIG. 6, and/or the computing system 100 may have a different configuration or arrangement of the components shown in FIG. 6. The various components shown in FIG. 6 may be implemented in hardware, software, or a combination of both hardware and software, including one or more signal processing and/or application specific integrated circuits.

Further, the acts of the processing methods described above may be implemented by running one or more functional modules in information processing apparatus such as general purpose processors or application specific chips, such as ASICs, FPGAs, PLDs, GPUs, coprocessors or other appropriate devices. These modules, combinations of these modules, and/or their combination with general hardware are all included within the scope of the present disclosure.

In light of the principles and example embodiments described and illustrated herein, it will be recognized that the example embodiments can be modified in arrangement and detail without departing from such principles. The foregoing discussion has focused on specific embodiments, but other configurations are also contemplated. In particular, even though expressions such as in “an embodiment,” or the like are used herein, these phrases are meant to generally reference embodiment possibilities, and are not intended to limit the disclosure to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

### REFERENCES

Duchi, J., E. Hazan, Y. Singer, 2011, Adaptive subgradient methods for online learning and stochastic optimization, Journal of Machine Learning Research, 12, 2121-2159
Guitton, A., 2017, Fast 3D least-squares RTM by preconditioning with nonstationary matching filters, SEG technical program expanded abstracts.
Gupta, V., K. Tomer, and Y. Singer, 2018, Shampoo: Preconditioned Stochastic Tensor Optimization, Proceedings of the 35^{th} International Conference on Machine Learning, 80, 1842-1850.
Hinton, G, 2018, Overview of mini-batch gradient descent, Coursera Neural Networks for Machine Learning, Lecture 6.
Newton, Isaac, 1711, De analysi per aequationes numero terminorum infinitas, William Jones, London.
Nocedal, J., and S. J. Wright, 2006, Numerical Optimization, Springer, P178
Operto, S., Y. Cholami, V. Prieux, A. Ribodetti, R. Brossier, L. Metivier, J. Virieux, 2013, A guided tour of multiparameter full-waveform inversion with multicomponent data: From theory to practice, The Leading Edge, 32, 1040-1054,
Plessix, R.-E., 2006, A review of the adjoint-state method for computing the gradient of a functional with geophysical application, Geophysical Journal International, 167, 2, 495-503
Raphson, Joseph, 1690, Analysis Aequationum Universalis, Abel Swale, London.
Tarantola, A., 1984, Inversion of seismic reflection data in the acoustic approximation, Geophysics, 49, 8, 1259-1266
Vozoff K. and Jupp, D. L. B. 1975: Joint inversion of geophysical data. Geophysical Journal of the Royal Astronomical Society 42, 977-991.
Wolfe, P. (1969). Convergence Conditions for Ascent Methods, SIAM Review. 11 (2): 226-235.
Yao, G., D. Wu. & S X. Wang, 2020, A review on reflection-waveform inversion, Petroleum Science. 17, 334-351.

What is claimed is:

1. A method for determining spatial distribution of properties of formations in a region of interest in the subsurface using geophysical sensor signals detected proximate the region, the method comprising:
inversion processing an initial model of the spatial distribution, the inversion processing comprising calculating expected geophysical sensor signals using the initial model and comparing the expected geophysical sensor signals to the detected geophysical sensor signals, the inversion processing comprising at least second order optimization, the at least second order optimization comprising;
calculating a scalar and a sparsity-modified matrix using an adaptive gradient type scheme to estimate an inverse Hessian matrix, and using the estimated inverse Hessian matrix in a modified limited memory Broyden-Fletcher-Goldfarb-Shanno (LBFGS) optimization; and
using the modified L-BFGS optimization to optimize the inversion processing, wherein an output of the optimized inversion processing comprises an updated model for which the expected geophysical sensor signals most closely match the detected geophysical sensor signals.

2. The method of claim 1 in which the sparsity-modified matrix comprises a Hadamard product of a sparsity imposing matrix with the matrix of diagonal and/or off-diagonal adaptive gradient type terms.

3. The method of claim 1 wherein diagonal terms and off-diagonal terms of the estimated inverse Hessian matrix are approximated by using a non-stationary convolution operator to produce an estimate of the inverse Hessian matrix.

4. The method of claim 3 wherein a plurality of convolution operators is used in products or in linear combinations, or in both products and linear combinations.

5. The method of claim 3 wherein at least one of the plurality of convolution operators comprises match filtering.

6. The method of claim 3 wherein the off-diagonal terms are modified to preserve a positive definite property.

7. The method of claim 5 wherein the match filtering is performed in a transformed domain comprising at least one of curvelet, Fourier, radon and wavelet domain.

8. The method of claim 5 wherein the match filtering is applied in at least one dimension.

9. The method of claim 5 wherein the match filtering is applied in overlapping windows.

10. The method of claim 1 wherein the adaptive gradient type scheme is regularized and/or constrained.

11. The method of claim 1 wherein an improved estimated inverse Hessian is obtained using a combination of data obtained at previous iteration steps.

12. A computer program stored in a non-transitory computer readable medium, the program having logic operable to cause a programmable computer to perform actions for determining spatial distribution of properties of formations in a subsurface volume using geophysical sensor signals detected proximate the volume, the actions comprising:
accepting as input to the computer the geophysical sensor signals;
inversion processing an initial model of the spatial distribution, the inversion processing comprising calculating expected geophysical sensor signals using the initial model and comparing the expected geophysical sensor signals to the detected geophysical sensor signals, the inversion processing comprising at least second order optimizing, the at least second order optimizing comprising, calculating a scalar and a sparsity-modified matrix using an adaptive gradient type scheme to estimate an inverse Hessian matrix in limited memory Broyden-Fletcher-Goldfarb-Shanno (L-BFGS) optimization, using the scaled sparsity-modified matrix to improve the estimated inverse Hessian matrix in order to optimize the inversion processing; finalizing the model of the spatial distribution when a value of an objective function in the inversion processing is minimized; and
generating an output representing the spatial distribution in the finalized model, wherein the output comprises the spatial distribution for which the calculated seismic signals most closely match the detected geophysical sensor signals.

13. The computer program of claim 12 in which the sparsity-modified matrix comprises a Hadamard product of a sparsity imposing matrix with the matrix of diagonal and/or off-diagonal adaptive gradient type terms.

14. The computer program of claim 12 wherein diagonal terms and off-diagonal terms of the estimated inverse Hessian matrix are improved by using a convolution operator.

15. The computer program of claim 14 wherein a plurality of convolution operators is used in products or in linear combinations, or in both products and linear combinations.

16. The computer program of claim 14 wherein the convolution operator comprises match filtering.

17. The computer program of claim 14 wherein the off-diagonal terms are modified to preserve a positive definite property.

18. The computer program of claim 16 wherein the match filtering is performed in a transformed domain comprising at least one of curvelet, Fourier, radon and wavelet domain.

19. The computer program of claim 16 wherein the match filtering is applied in at least one dimension.

20. The computer program of claim 16 wherein match filtering is applied in overlapping windows.

21. The computer program of claim 12 wherein the adaptive gradient type scheme is regularized and/or constrained.

22. The computer program of claim 12 wherein an improved inverse Hessian estimate is obtained using a combination of data obtained at previous iteration steps.

23. A method for determining spatial distribution of properties of formations in a region of interest in the subsurface using geophysical sensor signals detected proximate the region, the method comprising:
inversion processing an initial model of the spatial distribution, the inversion processing comprising calculating expected geophysical sensor signals using the initial model and comparing the expected geophysical sensor signals to the detected geophysical sensor signals, the inversion processing comprising at least second order optimization, the at least second order optimization comprising, calculating an estimate of an inverse Hessian as a convolutional operator (C), and using the estimated inverse Hessian in a modified limited memory Broyden-Fletcher-Goldfarb-Shanno (L-BFGS) optimization, using the modified L-BFGS optimization to optimize the inversion processing; and
generating an output of the inversion processing representing an optimized model of the spatial distribution wherein the calculated geophysical sensor signals most closely match the detected geophysical sensor signals.

24. The method of claim 23 wherein the convolutional operator comprises match filtering.

25. The method of claim 23 wherein off-diagonal terms of the estimated inverse Hessian matrix are modified to preserve a positive definite property.

26. The method of claim 24 wherein the match filtering is performed in a transformed domain comprising at least one of curvelet, Fourier, radon and wavelet domain.

27. The method of claim 24 wherein the match filtering is applied in at least one dimension.

28. The method of claim 24 wherein match filtering is applied in overlapping windows.

29. A computer program stored in a non-transitory computer readable medium, the program having logic operable to cause a programmable computer to perform actions for determining spatial distribution of properties of formations in a subsurface volume using geophysical sensor signals detected proximate the volume, the actions comprising:
accepting as input to the computer the geophysical sensor signals;
inversion processing an initial model of the spatial distribution, the inversion processing comprising calculating expected geophysical sensor signals using the initial model and comparing the calculated geophysical sensor signals to the detected geophysical sensor signals, the inversion processing comprising at least second order optimizing, the at least second order optimizing comprising, calculating an estimate of the inverse Hessian matrix as a convolutional operator and using the estimated inverse Hessian in a modified limited memory Broyden-Fletcher-Goldfarb-Shanno (L-BFGS) optimization, using the modified L-BFGS optimization to optimize the inversion processing; and
finalizing the model of the spatial distribution when a value of an objective function in the inversion processing is minimized, the finalized model representing the spatial distribution for which the expected geophysical sensor signals most closely match the detected geophysical sensor signals.

30. The computer program of claim 29 wherein the convolutional operator comprises match filtering.

31. The computer program of claim 30 wherein off-diagonal terms in the estimated inverse Hessian matrix are modified to preserve a positive definite property.

32. The computer program of claim 30 wherein the match filtering is performed in a transformed domain comprising at least one of curvelet, Fourier, radon and wavelet domain.

33. The computer program of claim 30 wherein the match filtering is applied in at least one dimension.

34. The computer program of claim 30 wherein the match filtering is applied in overlapping windows.
